(19) United States
(12) Patent Application Publication
(10) Pub. No.: US 2025/0035352 A1
(43) Pub. Date: Jan. 30, 2025

(54) A REFRIGERATION SYSTEM

(71) Applicant: Dyson Technology Limited, Malmesbury, Wiltshire (GB)

(72) Inventors: Robert James KYLE, Bristol (GB); Matthew Graham LEGG, Swindon (GB); Matthew Jerome JENNINGS, Cheltenham (GB); Samuel Thomas RAILTON, Bristol (GB)

(21) Appl. No.: 18/720,100

(22) PCT Filed: Oct. 27, 2022
(86) PCT No.: PCT/GB2022/052734

§ 371 Date: Jun. 14, 2024

(30) Foreign Application Priority Data
Dec. 22, 2021 (GB) 2118711.7

(51) Int. Cl. F25B 43/00; F25B 41/40

(52) U.S. Cl. CPC F25B 43/006; F25B 41/40

(57) ABSTRACT

Provided is refrigeration system having a circuit around which a refrigerant is circulatable. The circuit includes a compressor, a heat exchanger for exchanging heat between the refrigerant and a medium, and an accumulator for accommodating liquid refrigerant. The accumulator is fluidically coupled in a suction line between the heat exchanger and the compressor. The refrigeration system is operable in a cooling mode such that the medium is cooled at the heat exchanger, and the accumulator is oversized at a maximum cooling capacity of the refrigeration system in the cooling mode.

### TECHNICAL FIELD

The present invention relates to a refrigeration system.

### BACKGROUND

In some refrigeration systems, thermal energy may be transferred between a first heat exchanger and a second heat exchanger via a refrigerant.

### SUMMARY

The present invention provides a refrigeration system comprising a circuit around which a refrigerant is circulatable, the circuit comprising: a compressor; a heat exchanger for exchanging heat between the refrigerant and a medium; and an accumulator for accommodating liquid refrigerant, the accumulator fluidically coupled in a suction line between the heat exchanger and the compressor; wherein the refrigeration system is operable in a cooling mode such that the medium is cooled at the heat exchanger; and wherein the accumulator is oversized at a maximum cooling capacity of the refrigeration system in the cooling mode.

Optionally, the cooling mode is a variable cooling mode in which a level of cooling of the medium at the heat exchanger is variable. In other words, the cooling capacity of the refrigeration system is variable, such as by varying a speed of the compressor. In this case, the maximum cooling capacity is a maximum level of cooling of the medium at the heat exchanger that is achievable by the refrigeration system. This may be limited, for example, by a rating of the compressor, the type of refrigerant used, a level of charge of refrigerant in the refrigeration system, and/or the intended use of the refrigeration system, such as an intended temperature range of the medium.

In examples in which the cooling capacity of the refrigeration system is varied, in use, an amount of refrigerant circulating in the circuit may change. Specifically, as the cooling capacity is increased or decreased, and/or following a change in ambient conditions, such as a change in temperature and/or humidity of the medium, there may be a change in the proportion of vaporous refrigerant compared to liquid refrigerant circulating in the circuit. In this way, the accumulator may act as a buffer to accommodate excess liquid refrigerant from, and/or release surplus refrigerant to, the circuit as the cooling capacity is varied. During operation in the first mode, the largest quantity of liquid refrigerant to be stored may occur when the refrigeration system is operated to provide the maximum cooling capacity. In this way, the accumulator is configured to accommodate a greater volume of liquid refrigerant than would otherwise be required to provide the maximum cooling capacity. The accumulator may be oversized throughout the full range of operating conditions of the refrigeration system in the cooling mode.

Optionally, the accumulator is configured to store up to 10%, up to 25%, up to 50%, up to 100%, up to 200%, or over 200% more liquid refrigerant than would be required for the refrigeration system to provide the maximum cooling capacity.

Optionally, the accumulator comprises a chamber for storing refrigerant. Optionally, the accumulator comprises an outlet comprising a standpipe configured to open into the chamber.

In this way, the refrigerant is provided to the compressor via the standpipe. The accumulator may be configured to store liquid refrigerant in the chamber. Where an upper opening of the standpipe is above the liquid line of the refrigerant in the chamber, in use, the accumulator may provide mostly, or only, vaporous refrigerant to the compressor via the standpipe. In this way, the accumulator may provide a dual function to: a) act as a buffer for accommodating excess liquid refrigerant in the circuit as described above and b) reduce the ingestion of liquid refrigerant in the compressor. This may allow the refrigeration system to provide variable cooling in the cooling mode, while improving an efficiency and/or longevity of the compressor.

Optionally, the accumulator and/or the standpipe comprises, and/or is formed from, a metal, such as copper and/or aluminium. Optionally, the accumulator is formed from a spun copper bulb. Alternatively, the accumulator and/or the standpipe comprises any other suitable material, such as any other suitable metal and/or a polymer. Optionally, the material is thermally conductive. Optionally, the accumulator and/or the standpipe comprises, and/or is formed from, a thermally insulative material. Optionally, the accumulator is formed from any suitable material and is surrounded by a thermally insulative material. Providing such thermal insulation may limit undesirable heat transfer between the refrigerant and an environment in which the accumulator is located. This may reduce an amount of condensate forming on an outer surface of the accumulator, in use.

Optionally, the accumulator is configured so that the standpipe always opens into the chamber above a free surface level of liquid refrigerant in the chamber when the refrigeration system is operated in the cooling mode.

In other words, the chamber is large enough to accommodate excess refrigerant in the circuit in the cooling mode at maximum cooling capacity while maintaining a free surface level of refrigerant that is below the opening into the standpipe. This may prevent liquid ingestion into the compressor in the cooling mode, thereby increasing an efficiency and/or longevity of the compressor.

Optionally, the circuit comprises a further heat exchanger for exchanging heat between the refrigerant and a second medium. Optionally, the second medium is a thermal store.

Optionally, the refrigeration system comprises the thermal store.

Optionally, the thermal store comprises a phase change material.

As a result, advantage may be taken of the latent heat capacity of the phase change material to store more thermal energy for a given temperature change.

Optionally, in the cooling mode, the second medium is heated at the further heat exchanger. In this way, where the second medium is a thermal store, the thermal store is heated at the further heat exchanger.

In this way, the heat extracted from the medium at the heat exchanger in the cooling mode may be stored at the thermal store via the further heat exchanger. Where the thermal store comprises a phase change material, the thermal store is capable of storing and releasing relatively large amounts of heat for a given temperature range by taking advantage of the latent heat capacity of the phase change material. Accordingly, in the cooling mode, the refrigeration system may store a greater amount of heat in the thermal store and thus provide cooling over a longer period of time.

Optionally, the circuit comprises a metering device. Optionally, the metering device has a first restriction in the cooling mode. Optionally, the refrigeration system is operable in a regeneration mode in which the metering device has a second restriction, less restrictive than the first restriction, or is bypassed, such that the thermal store is cooled at the further heat exchanger and the medium is heated at the heat exchanger.

In other words, the metering device is configured to restrict a flow of refrigerant from the further heat exchanger to the heat exchanger in the cooling mode. In the regeneration mode, a flow of refrigerant from the further heat exchanger to the heat exchanger may be unrestricted, such as by bypassing the metering device, or by the metering device providing no restriction to the flow. The thermal store is cooled by ensuring that the pressure of the refrigerant is not reduced by the metering device. This differs from a conventional reversible refrigeration cycle in which the pressure is reduced by the metering device in both modes.

Where the refrigeration system comprises the further heat exchanger, and the thermal store comprises the phase change material, the phase change material may have a melting point greater than an ambient temperature of the medium. This then has the advantage that heat stored by the thermal store may be expelled to the medium when cooling is not required, such as in the regeneration mode. A relatively high melting point has the advantage of increasing the rate at which heat is expelled, and thus decreasing the time required to regenerate the thermal store. A relatively low melting point, on the other hand, has the advantage of improving the efficiency of the refrigeration system in the cooling mode. A relatively good balance between these two competing factors may be achieved with a phase change material having a melting point of between 30° C. and 80° C. In some examples, the phase change material may comprise an organic wax or inorganic salt hydrate.

Optionally, the accumulator is sized to accommodate liquid refrigerant in the refrigeration system when the refrigeration system is operated in the regeneration mode.

The accumulator, in the regeneration mode, may be sized to accommodate refrigerant that would otherwise be present in a liquid line between the compressor and the metering device, or other components of the refrigeration system, in the cooling mode.

In other words, when the refrigeration system is operated in the cooling mode, such as to provide up to the maximum cooling capacity achievable by the refrigeration system, an amount of liquid refrigerant may be present in the circuit, such as in and/or downstream of the further heat exchanger, such as in the liquid line. When the refrigeration system is operated in the regeneration mode, the amount of liquid refrigerant circulating in the circuit may be reduced. Specifically, in the regeneration mode, most, or all, of the refrigerant circulating in the circuit, such as through the further heat exchanger and/or the liquid line, may be a vapour. There may also be more liquid refrigerant present in the suction line during the regeneration mode, due to a cooling of the refrigerant through the heat exchanger. In this way, the accumulator may be sized to accommodate the excess liquid refrigerant from the circuit, and/or excess liquid refrigerant in the suction line, in the regeneration mode.

Optionally, when the accumulator comprises the chamber and the standpipe, the accumulator is configured so that the standpipe opens into the chamber above a free surface level of refrigerant in the chamber when the refrigeration system is operated in the regeneration mode.

By providing such an accumulator in the suction line, only vaporous refrigerant may be returned to the compressor during operation of the refrigeration system in the regeneration mode. This may allow the regeneration mode to be performed by the refrigeration system, and/or may improve an efficiency and/or longevity of the compressor when operating in the regeneration mode. Such an accumulator also acts as a refrigerant buffer, specifically to accommodate excess refrigerant to allow the refrigeration system to operate in a variable cooling mode, as well as in the regeneration mode. By providing such an oversized accumulator in the suction line, a separate accumulator may not need to be provided elsewhere in the system, such as in the liquid line, as might be the case in a conventional refrigeration system.

Optionally, the refrigerant circulates around the circuit in the same direction in both the cooling mode and the regeneration mode.

As a result, the cooling and heating functions of the heat exchangers may be reversed without requiring a complicated valve arrangement, thereby simplifying the refrigeration system.

Optionally, the refrigeration system is configured so that the refrigerant undergoes a phase transition in the cooling mode only.

That is, there may be no phase transition in the regeneration mode. In particular, the refrigerant in the circuit may transition between two states of matter as it passes through the circuit (e.g. liquid and vapour) in the cooling mode, and may be in a single state throughout the circuit in the regeneration mode (e.g. liquid or vapour).

Optionally, the metering device comprises a variable expansion valve and/or the circuit comprises a bypass valve for bypassing the metering device.

The variable expansion valve may be an expansion valve having a variable restriction. The variable expansion valve may have the first restriction, or the bypass valve may be closed, in the cooling mode, and the expansion valve may have the second restriction, or the bypass valve may be open, in the regeneration mode. A variable expansion valve may provide an efficient mechanism for achieving different refrigerant pressures in the two modes, whereas the bypass valve may provide a more cost-effective mechanism.

Optionally, the refrigeration system comprises a controller for switching between the cooling mode and the regeneration mode in response to an input.

The controller is then able to control whether heating or cooling occurs at each of the heat exchangers. For example, the controller may switch to the regeneration mode to cool the thermal store when cooling at the heat exchanger is not required.

The refrigeration system may comprise a temperature sensor for measuring a temperature of the thermal store. The controller may switch between the cooling mode and the regeneration mode in response to changes in the temperature of the thermal store as measured by the temperature sensor. The controller may then control the operation of the refrigeration system so as to avoid excessive heating of the thermal store, as well as ineffective or inefficient cooling.

The controller may switch from the cooling mode to the regeneration mode in response to the temperature of the thermal store exceeding a threshold. The threshold may represent a temperature at which the refrigeration system is no longer able to effectively or efficiently cool the medium at the first heat exchanger.

The input may be provided by at least one of a user interface and a temperature sensor. The user interface may form part of the refrigeration system (e.g. a dedicated interface). Alternatively, the user interface may form part of a separate device, such as a mobile phone, tablet or other computing device, connected to the controller via a wireless interface. Advantageously, this enables a user to control the refrigeration system. For example, a user can specify a target temperature, when cooling of the medium at the heat exchanger should occur and/or when cooling of the thermal store at the further heat exchanger should occur.

The temperature sensor may comprise a room thermostat connected to the controller via a wired or wireless interface. This may enable the user to specify a desired room temperature via the thermostat and the refrigeration system to maintain a room at the desired temperature, such as by adjusting a temperature of the medium, where the medium is air in the room.

A second aspect of the present invention provides a heating, ventilation, and air conditioning (HVAC) system comprising the refrigeration system of the first aspect.

It will be appreciated that any of the optional features and advantages of the first aspect may similarly apply to the second aspect.

A third aspect of the present invention provides a fan assembly comprising the refrigeration system of the first aspect, or the HVAC system of the second aspect.

The fan assembly may comprise an airflow generator for generating airflow through the fan assembly. The medium may be the airflow generated through the fan assembly.

By employing a refrigeration system that comprises a thermal store, a compact and self-contained fan assembly may be achieved. In particular, the fan assembly may cool the airflow, and the heat extracted from the airflow may be stored in the thermal store. The fan assembly may therefore be located within a room or other medium being cooled. By contrast, with a conventional air conditioning unit having a refrigeration system, the heat extracted from the cooled air is typically expelled to an area outside the room or other medium being cooled. As a result, the refrigeration system is typically larger and more complex.

The fan assembly may comprise a nozzle having an outlet through which the airflow is emitted from the fan assembly. Providing a nozzle may enable improved control over the direction of the emitted airflow. For example, the nozzle may be moveable or comprise moveable parts (e.g. slats or louvres) to change the direction of the airflow. This then enables the emitted airflow to be targeted in different directions.

It will be appreciated that any of the optional features and advantages of the first aspect and/or the second aspect may similarly apply to the third aspect.

### BRIEF DESCRIPTION OF THE DRAWINGS

Embodiments will now be described, by way of example, with reference to the accompanying drawings in which:

FIG. 1 shows a schematic of a refrigeration system in a first mode;

FIG. 2 shows a schematic of the refrigeration system of FIG. 1 in a second mode;

FIG. 3 shows a schematic of an alternative refrigeration system in a first mode;

FIG. 4 shows a schematic of the alternative refrigeration system of FIG. 3 in a second mode;

FIG. 5 shows a schematic of an accumulator of the refrigeration system of any of FIGS. 1 to 4;

FIG. 6A shows an isometric view of an example fan assembly comprising the refrigeration system of any of FIGS. 1 to 4; and

FIG. 6B shows an alternative, schematic view of the fan assembly of FIG. 6A.

### DETAILED DESCRIPTION

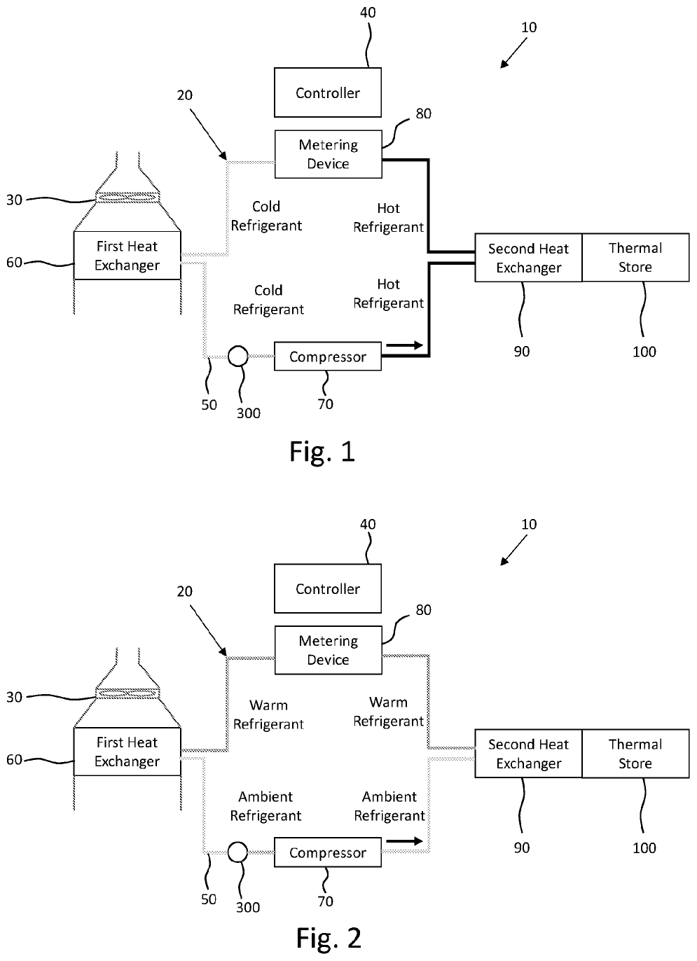

FIGS. 1 and 2 show an example refrigeration system 10 comprising a circuit 20, a blower 30 and a controller 40. The circuit 20 comprises a series of pipes 50, a first heat exchanger 60, an accumulator 300, a compressor 70, a metering device 80, a second heat exchanger 90, and a thermal store 100.

The series of pipes 50 connect the first heat exchanger 60 to the compressor 70, via the accumulator 300, the compressor 70 to the second heat exchanger 90, the second heat exchanger 90 to the metering device 80 and the metering device 80 to the first heat exchanger 60 such that a refrigerant can circulate around the circuit 20.

The first heat exchanger 60 is located downstream of the metering device 80 and upstream of the accumulator 300 and compressor 70, and exchanges heat between the refrigerant and a medium, such as air. The second heat exchanger 90 is downstream of the compressor 70 and upstream of the metering device 80, and exchanges heat between the refrigerant and the thermal store 100.

The compressor 70 drives the refrigerant around the circuit 20 in a direction, shown in FIG. 1, such that the refrigerant circulates from the compressor 70 to the second heat exchanger 90, from the second heat exchanger 90 to the metering device 80, from the metering device 80 to the first heat exchanger 60 and from the first heat exchanger 60 to the compressor 70, via the accumulator 300. In some modes of operation, discussed subsequently, the compressor 70 may additionally compress the refrigerant.

The metering device 80 is operable in a restricted state and an unrestricted state. In the restricted state, the refrigerant flowing through the metering device 80 expands and the pressure and temperature of the refrigerant decreases. In the unrestricted state, the refrigerant flowing through the metering device 80 does not expand and the pressure and temperature of the refrigerant is unchanged. In this example, the metering device 80 comprises a variable expansion valve. In the restricted state, the variable expansion valve has a first restriction, and in the unrestricted state, the variable expansion valve has a second, less restrictive restriction.

The thermal store 100 stores thermal energy for transfer to and from the refrigerant in order to heat and cool the refrigerant. In this particular example, the thermal store 100 comprises a phase change material. This then has the benefit that the thermal store 100 can take advantage of the latent heat capacity of the phase change material to store more thermal energy for a given change in temperature. In one example, the phase change material may be an organic wax or inorganic salt hydrate having a melting point of between 45° C. and 50° C.

The blower 30 comprises a fan driven by a motor for blowing a medium, such as air, over the first heat exchanger 60.

The controller 40 controls the compressor 70, the metering device 80 and the blower 30. For example, the controller 40 may power on and off the compressor 70 and the blower 30, as well as control the state of the metering device 80. The controller 40 may additionally control the speed of the compressor 70 and/or the blower 30.

The refrigeration system 10, under the control of the controller 40, is operable in a first mode and a second mode. The first mode may be referred to herein as a “cooling mode”, and the second mode may be referred to herein as a “regeneration mode”, for reasons which will become apparent from the following description.

In the first mode, shown in FIG. 1, the controller 40 moves the metering device 80 to the restricted state and operates the blower 30 at a first speed. As a consequence of the metering device 80 being in the restricted state, the pressure and temperature of the refrigerant flowing though the metering device 80 decreases. In this particular example, the refrigerant remains in the liquid state, but could conceivably undergo a phase transition from a liquid state to a liquid-vapour state. The refrigerant flowing through the first heat exchanger 60 is at a lower temperature than the air moving over the first heat exchanger 60. Consequently, the first heat exchanger 60 acts as an evaporator to cool the air, and heat and vaporise the refrigerant. The refrigerant therefore undergoes a phase transition from a liquid state to a vapour state. The refrigerant then flows from the first heat exchanger 60 to the compressor 70, via the accumulator 300, which will be described in more detail below. At the compressor 70, the refrigerant is compressed to increase the pressure, and thus the temperature, of the refrigerant. The compressed refrigerant leaving the compressor 70 is in a vapour phase, or a mostly vapour phase. The refrigerant then flows through the second heat exchanger 90, which exchanges heat between the refrigerant and the thermal store 100. The refrigerant flowing through the second heat exchanger 90 is at a higher temperature than the thermal store 100. As a result, the second heat exchanger 90 acts as a condenser to heat the thermal store 100, and cool and condense the vaporous refrigerant. The refrigerant therefore undergoes a phase transition from a vapour state to a liquid state in the second heat exchanger 90. The refrigerant then flows to the metering device 80, and the cycle is repeated.

In the second mode, shown in FIG. 2, the controller 40 moves the metering device 80 to the unrestricted state and operates the blower 30 at a second speed. As a consequence of the metering device 80 being in the unrestricted state, the pressure and temperature of the refrigerant flowing though the metering device 80 is unchanged. In this particular example, the refrigerant is in a vapour state, but could conceivably be in a liquid-vapour or a liquid state. Refrigerant flowing through the first heat exchanger 60 is at a higher temperature than the air moving over the first heat exchanger 60. Consequently, the air is heated, and the refrigerant is cooled. In this particular example, the refrigerant is not cooled below its boiling point and thus the refrigerant does not condense or undergo a phase change. The refrigerant then flows from the first heat exchanger 60 to the accumulator 300, and then to the compressor 70. Owing to the unrestricted state of the metering device 80, the compressor 70 does not compress the refrigerant. The refrigerant then flows through the second heat exchanger 90, which exchanges heat between the refrigerant and the thermal store 100. The refrigerant flowing through the second heat exchanger 90 is at a lower temperate than the thermal store 100, due to its cooling at the first heat exchanger 60. As a result, the thermal store 100 is cooled, and the refrigerant is heated. In this particular example, the refrigerant flowing through the second heat exchanger 90 is in a vapour state and does not therefore undergo a phase transition. The refrigerant then flows to the metering device 80, and the cycle is repeated.

In some examples, the first mode is a variable cooling mode, in which a level of cooling of the medium at the first heat exchanger is variable. This is, for example, by varying the speed of the compressor 70 and/or the blower 30. In other examples, this is by changing a pressure drop across the metering device 80, such as by varying a level of restriction through the metering device. A level of cooling may also change depending on a temperature of the medium and/or the thermal store 100. As the level of cooling is changed, different quantities of refrigerant may be present in different phases throughout the circuit 20. For example, when providing a low, or minimum, level of cooling in the first mode (i.e. a low rate of heat transfer from the second heat exchanger 90 to the first heat exchanger 60), the second heat exchanger may comprise more liquid refrigerant than at a higher level of cooling. On the other hand, at a higher, or maximum level of cooling, or “maximum cooling capacity”, achievable by the refrigeration system 10 in the first mode, there may be a higher proportion of vaporous refrigerant circulating in the circuit than liquid refrigerant, and less refrigerant in the pipes 50 and various components of the circuit 10 overall.

The accumulator 300 is configured to accommodate excess liquid refrigerant in the circuit 20, particularly when the refrigeration system is operated to provide a higher level of cooling. It also acts as a source of refrigerant that can be circulated in the circuit 20 as the level of cooling is reduced. The accumulator 300 here is oversized at the maximum cooling capacity of the refrigeration system in the first mode. In other words, the accumulator 300 is configured to accommodate a greater volume of liquid refrigerant than would otherwise be required to provide the maximum cooling capacity. The maximum cooling capacity may be limited, for instance, by a rating of the compressor 70, the type of refrigerant used in the refrigeration system 10, a level of charge of refrigerant in the refrigeration system 10, and/or the intended use of the refrigeration system 10, such as an intended temperature range of the medium.

In the second mode, as noted above, there is primarily vaporous refrigerant circulating around the circuit 20. This is in contrast to the first mode, in which, even at maximum cooling capacity, there will be some liquid refrigerant present in at least a liquid line between the second heat exchanger 90 and the metering device 80, and in the line between the metering device 80 and the first heat exchanger 60. There will also be less refrigerant circulating around the circuit 20 overall in the second mode than in the first mode. As such, the accumulator 300 is sized to at least accommodate this excess refrigerant when the refrigeration system 10 is operated in the second mode. In some examples, the accumulator 300 is similarly oversized for this purpose, in order to provide a significant refrigerant buffer in the circuit.

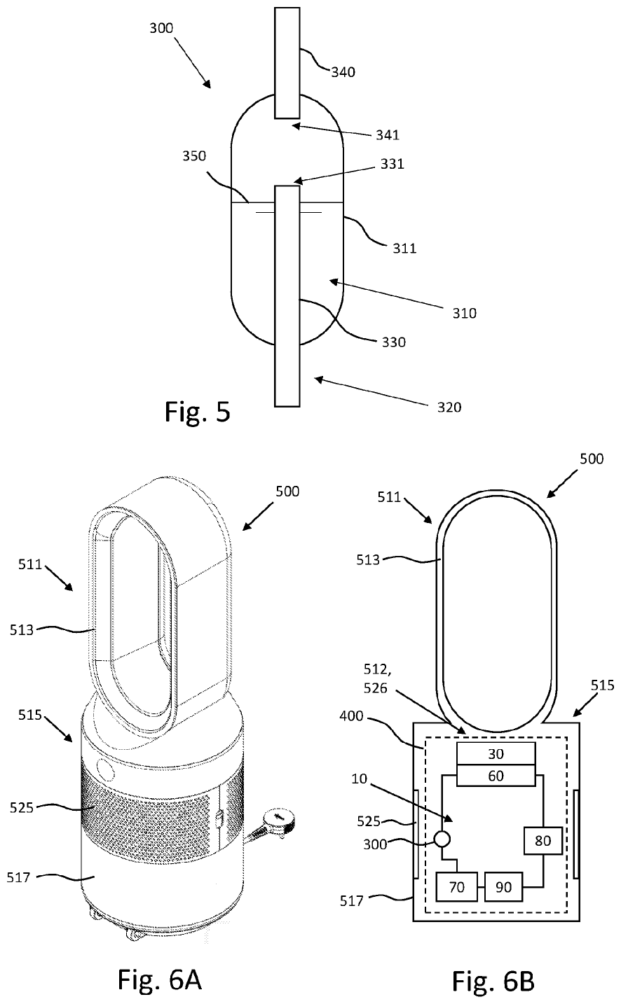

As will be described in more detail below with reference to FIG. 5, the accumulator 300 is also configured to separate liquid and gaseous refrigerant, so that only gaseous refrigerant is returned to the compressor 70 in the first and second modes. In this way, the accumulator 300 serves a dual purpose, to both prevent liquid ingestion of refrigerant in the compressor, and to act as a buffer for liquid refrigerant in the circuit 20. Moreover, if the second, regeneration mode were to be omitted, it might be typical to locate a refrigerant buffer, such as a receiver, in the liquid line between the second heat exchanger 90 and the metering device 80 to accommodate excess refrigerant as the cooling capacity is varied in the first mode. Providing the oversized, dual-purpose accumulator between the first heat exchanger 60 and the compressor 70 allows the refrigeration system 10 to operate in both the first and second modes without requiring an additional buffer in the liquid line, and without changing a direction of flow of refrigerant through the circuit 20, which would otherwise require a complex valve arrangement. This leads to a simpler refrigeration system 10 that is able to cool the thermal store 100 when it is not required to provide cooling to the medium.

The controller 40 switches between the first mode and the second mode in response to an input. In this example, the refrigeration system 10 comprises a temperature sensor for measuring a temperature of the thermal store 100 and the controller 40 switches between the first mode and the second mode in response to changes in the temperature of the thermal store 100 as measured by the temperature sensor. In particular, the controller 40 switches to the second mode in response to the temperature of the thermal store 100 exceeding an upper threshold. The bigger the difference in the temperatures of the first and second heat exchangers (i.e. the hot and cold sides of the refrigeration system), the less efficient the system becomes. The upper threshold may therefore represent a temperature above which the refrigeration system 10 is no longer able to effectively or efficiently cool the air. Alternatively, the upper threshold may represent a temperature above which the volume expansion of the thermal store becomes excessive, or the temperature of the thermal store becomes excessively hot, which may present a safety concern or may lead to adverse changes in the physical and/or chemical properties of the thermal store. Moreover, the upper threshold may represent a temperature above which the pressure of the refrigerant becomes excessive. The controller 40 then switches to the first mode in response to the temperature of the thermal store 100 being below a lower threshold. As noted above, the efficiency of the refrigeration system increases as the difference in the temperatures of the first and second heat exchangers decreases. The lower threshold may therefore represent a temperature below which the refrigeration system 10 is able to effectively or efficiently cool the air. Where the thermal store comprises a phase change material, the upper and lower thresholds may be respectively greater and lower than the melting point of the phase change material. For example, where the phase change material has a melting point of 46° C., the upper threshold may be 48° C. and the lower threshold may be 44° C. Thereby the refrigeration system 10 operates in the first mode to cool the air at the first heat exchanger 60 and heat the thermal store at the second heat exchanger 90. The refrigeration system 10 operates in the first mode until the temperature of the thermal store exceeds the upper threshold. The refrigeration system 10 then switches to the second mode to heat the air at the first heat exchanger 60 and cool the thermal store 100 at the second heat exchanger 90. The refrigeration system 10 continues to operate in the second mode until the temperature of the thermal store 100 drops below the lower threshold, at which point the refrigeration system 10 switches to the first mode.

In a further example, the input may be provided by a user interface. The user interface may form part of the refrigeration system 10 (e.g. a dedicated interface) or the user interface may form part of a separate device, such as a mobile phone, tablet or other computing device, connected to the controller 40 via a wireless interface. A user is thereby able to control the refrigeration system 10. In one example, the user can specify a target temperature for the air, and the controller 40 may operate the refrigeration system 10 so as to maintain the air at the target temperature. In a second example, the user may schedule times when cooling is desired (e.g. during the day time), and the controller 40 may switch the refrigeration system to the first mode to cool the air when cooling is scheduled, and switch the refrigeration system to the second mode to cool the thermal store 100 when cooling is not scheduled (e.g. overnight). In a third example, geofencing may be employed such that when the user is at home, the controller 40 switches the refrigeration system 10 to the first mode, and when the user is away from home, the controller 40 switches the refrigeration system 10 to the second mode. The user interface may also be used, for example, to adjust or control the speed of the blower 30.

The input could also be provided by a temperature sensor such as a room thermostat. The controller 40 may turn the refrigeration system 10 on and off in response to changes in the air temperature such that the refrigeration system 10 maintains a room at the desired temperature.

With the refrigeration system 10 described above, air is cooled at the first heat exchanger 60 and the thermal store 100 is heated at the second heat exchanger 90 when operating in the first mode. The air is cooled at the first heat exchanger 60 by employing a first restriction at the metering device 80, which reduces the pressure and thus the temperature of the refrigerant. When operating in the second mode, air is heated at the first heat exchanger 60 and the thermal store 100 is cooled at the second heat exchanger 90. The thermal store 100 is cooled by employing a second, less restrictive restriction at the metering device 80, which does not reduce the pressure of the refrigerant. With conventional refrigeration cycles, heating and cooling of a thermal store may be achieved by having a reversible refrigerant flow, typically requiring a four-way valve or the like. With the refrigeration system 10 described above, refrigerant circulates around the circuit 20 in the same direction in both the first mode and the second mode. In particular, the compressor 70 drives the refrigerant around the circuit 20 in the same direction in both modes. As a result, heating and cooling of the thermal store 100 may be achieved without the need for a four-way valve. A potential drawback of the refrigeration system 10 is that the rate of cooling of the thermal store 100 is likely to be lower than that which can be achieved with a reversible refrigeration cycle. However, this potential drawback may be offset by the cost-savings that can be achieved through the omission of a four-way valve.

The thermal store 100 may comprise a phase change material. This then enables advantage to be taken of the latent heat capacity of the phase change material to store more thermal energy for a given temperature change. As a result, the refrigeration system 10 may provide cooling at the first heat exchanger 60 for a longer period. Nevertheless, the refrigeration system may operate with a thermal store 100 that does not comprise a phase change material.

The refrigerant undergoes a phase transition in the first mode only. However, other embodiments are envisaged in which the refrigerant undergoes a phase transition in the second mode.

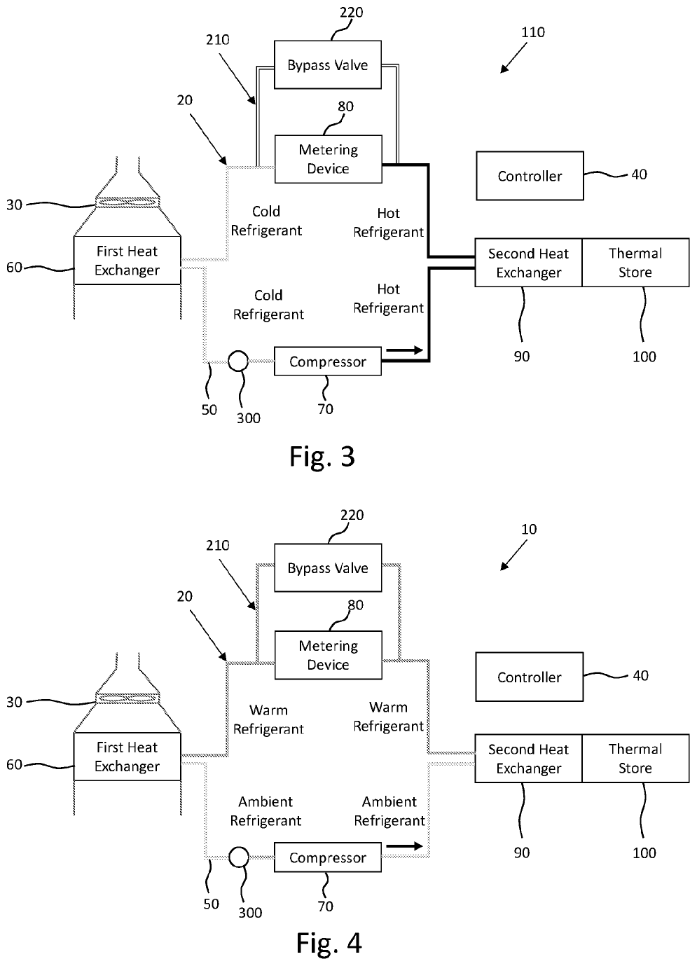

In the example described above, the metering device 80 has an unrestricted state in the second mode. As a result, the pressure and temperature of the refrigerant at the metering device 80 is unchanged. This effect, namely no change in pressure or temperature at the metering device 80, can be achieved by other means. For example, as will now be described with reference to FIGS. 3 and 4, the refrigeration system may comprise a bypass valve for bypassing the metering device in the second mode.

FIGS. 3 and 4 show a further example of a refrigeration system 110. The refrigeration system 110 is identical to that described above and shown in FIGS. 1 and 2, with two exceptions. First, the metering device 80 has a restricted state only, i.e. the metering device 80 does not have an unrestricted state. When refrigerant flows through the metering device 80, the refrigerant expands and the pressure and temperature of the refrigerant decrease. In this example, the metering device 80 comprises a capillary tube that provides a restriction in the circuit 20. Second, the refrigeration system 110 comprises a bypass loop 210.

The bypass loop 210 comprises a first pipe, a second pipe and a bypass valve 220. The first pipe connects the bypass valve 220 to the circuit 20 between the metering device 80 and the second heat exchanger 90, and the second pipe connects the bypass valve 220 to the circuit 20 between the metering device 80 and the first heat exchanger 60. The bypass valve 220 is operable in a closed state and an open state. In the closed state, refrigerant flows through the metering device 80 whereupon the refrigerant expands and the pressure and temperature of the refrigerant decreases. In the open state, refrigerant flows through the bypass loop 210 to bypass the metering device 80. Thereby, the refrigerant does not expand, and the temperature and pressure of the refrigerant is unchanged. In this particular example, the bypass valve 220 comprises a solenoid for moving the bypass valve 220 between the closed state and the open state under the control of the controller 40.

The refrigeration system 110 is again operable in a first mode and a second mode.

In the first mode, shown in FIG. 3, the controller 40 moves the bypass valve 220 to the closed state such that the refrigerant flows through the metering device 80. As a consequence of the metering device 80 having a restriction, the pressure and temperature of the refrigerant flowing though the metering device 80 decreases. In this particular example, the refrigerant remains in the liquid state, but could conceivably undergo a phase transition from a liquid state to a liquid-vapour state. The refrigerant flowing through the first heat exchanger 60 is at a lower temperature than the air moving over the first heat exchanger 60. Consequently, the first heat exchanger 60 acts as an evaporator to cool the air, and heat and vaporise the refrigerant. The refrigerant therefore undergoes a phase transition from a liquid state to a vapour state. The refrigerant then flows from the first heat exchanger 60 to the compressor 70, whereupon the refrigerant is compressed to increase the pressure, and thus the temperature, of the refrigerant. The refrigerant then flows through the second heat exchanger 90, which exchanges heat between the refrigerant and the thermal store 100. The refrigerant flowing through the second heat exchanger 90 is at a higher temperature than the thermal store 100. As a result, the second heat exchanger 90 acts as a condenser to heat the thermal store 100, and cool and condense the refrigerant. The refrigerant therefore undergoes a phase transition from a vapour state to a liquid state. The refrigerant then flows to the metering device 80, and the cycle is repeated.

In the second mode, shown in FIG. 4, the controller 40 moves the bypass valve 220 to the open state such that the refrigerant flows through the bypass loop 210 and bypasses the metering device 80. As a consequence of the refrigerant bypassing the metering device 80, the pressure and temperature of the refrigerant flowing though the bypass loop 210 is unchanged. In this particular example, the refrigerant is in a vapour state. Refrigerant flowing through the first heat exchanger 60 is at a higher temperature than the air moving over the first heat exchanger 60. Consequently, the air is heated and the refrigerant is cooled. In this particular example, the refrigerant is not cooled below its boiling point and thus the refrigerant does not condense or undergo a phase change. The refrigerant then flows from the first heat exchanger 60 to the compressor 70. Owing to refrigerant bypassing the metering device 80, the compressor 70 does not compress the refrigerant but instead acts to drive the refrigerant around the circuit 20. The refrigerant then flows through the second heat exchanger 90, which exchanges heat between the refrigerant and the thermal store 100. The refrigerant flowing through the second heat exchanger 90 is at a lower temperate than the thermal store 100. As a result, the thermal store 100 is cooled, and the refrigerant is heated. In this particular example, the refrigerant flowing through the second heat exchanger 90 is in a vapour state and does not therefore undergo a phase transition. The refrigerant then flows to the bypass loop 210, and the cycle is repeated.

The refrigeration system 110 of FIGS. 3 and 4 thereby realises the same benefits as the refrigeration system 10 of FIGS. 1 and 2. In contrast to the refrigeration system 10 of FIGS. 1 and 2, in which the metering device 80 comprises a variable expansion valve, the refrigeration system 110 comprises a bypass valve 220 for bypassing the metering device 80. A variable expansion valve may provide an efficient mechanism for achieving different refrigerant pressures in the two modes, whereas the bypass valve 220 may provide a more cost-effective mechanism.

FIG. 5 shows a schematic example construction of the accumulator 300. The accumulator 300 comprises a chamber 310 for storing refrigerant, and an outlet 320 comprising a stand pipe 330 that is configured to open into the chamber 310 at a standpipe opening 331. The accumulator 300 also comprises an inlet 340 which opens into the chamber 310 at an inlet opening 341. The inlet 340 is shown in FIG. 5 to open into the chamber 310 vertically, opposite the standpipe 330, though it will be appreciated that the inlet may open into the chamber 310 in any other suitable location, such as offset from the standpipe 330, horizontally, and/or below the standpipe opening 332.

The accumulator 300 is configured so that the standpipe 330 always opens into the chamber above a free surface level 350 of liquid refrigerant in the chamber 310 when the refrigeration system is operated in the cooling mode. In other words, the chamber 310 is large enough to accommodate excess refrigerant in the circuit in the cooling mode at the maximum cooling capacity while maintaining a free surface level 350 of refrigerant that is below the standpipe opening 331. In this way, only, or mostly, gaseous refrigerant is passed to the compressor 70 from the accumulator 300 via the standpipe 330.

The accumulator 300 and/or the standpipe 330 comprises, and/or is formed from, a metal, such as copper and/or aluminium. In other words, a shell 311 defining the chamber 310 comprises, and/or is formed from, the thermally conductive material. Specifically, the shell 311 is formed from a spun copper bulb. In other examples, the accumulator 300 and/or the standpipe 330 is formed from any other suitable material, such as a metal and/or a polymer. In some examples, the accumulator 300 comprises, is formed by, and/or is surrounded by, a thermally insulative material.

FIGS. 6A and 6B show an example fan assembly 500 comprising the refrigeration system 10. Specifically, as best shown in FIG. 6B, the fan assembly 500 comprises a Heating, Ventilation and Air Conditioning (HVAC) system 400 comprising the refrigeration system 10. The fan assembly 500 also comprises a nozzle 511 and a main body 515.

The nozzle 511 is attached to the main body 515 and comprises a nozzle inlet 512 for receiving an airflow from the main body 515, and a nozzle outlet 513 for emitting the airflow. In the example of FIGS. 6a and 6b, the nozzle 511 is generally racetrack-shaped, the nozzle inlet 526 comprises an opening in a base of the nozzle 511, and the nozzle outlet 513 comprises a pair of slots that each extend along straight portions of the nozzle 511. In some examples, the nozzle 511 may comprise slats, louvres or other means for changing the direction of the airflow emitted from the nozzle outlet 513. Thereby, the direction of the airflow may be changed without the need to rotate the nozzle 511 or main body 515.

The main body 515 comprises a housing 517, the refrigeration system 10 and an airflow generator, which here is the blower 30 of the refrigeration system 10. The housing 517 houses the HVAC system 400, and specifically the refrigeration system 10 and the blower 30.

The housing 517 comprises a housing inlet 525 through which an airflow is drawn into the main body 515, and a housing outlet 526 through which the airflow is emitted into the nozzle 511, specifically via the nozzle inlet 512. In the illustrated example, the housing 517 is cylindrical in shape, the housing inlet 525 comprises a plurality of apertures in a side wall of the housing 517, and the housing outlet 526 comprises an opening in a top wall of the housing 517.

The blower 30 comprises an impeller driven by an electric motor. The blower 30 generates an airflow between the housing inlet 525 and the housing outlet 526 of the main body 515. More particularly, the airflow is drawn into the housing 517 via the housing inlet 525, whereupon the airflow moves over the first heat exchanger 60 of the refrigeration system 10 as described above to condition the airflow. The conditioned airflow then moves through the blower 30, and is emitted from the main body 515 via the housing outlet 526.

The fan assembly 500 is intended to be used primarily to provide a cooled airflow. This cooled airflow may be used, for example, to cool a person or a room. To achieve this, the refrigeration system 10 of the fan assembly 500 operates in the first mode as described above.

During periods when cooling is not required, or when a maximum heat storage capacity of the thermal store 100 has been reached, the fan assembly 500 may operate in the second, regeneration mode. In the second mode, the fan assembly 500 expels the heat that was stored during the first mode. As a warmed airflow is emitted from the fan assembly 500 when operating in the regeneration mode, regeneration of the thermal store 100 may occur at times when the room is unoccupied (or unlikely to be occupied) or at times when warming is actually desirable. For example, the fan assembly 500 may be scheduled to operate in the cooling mode during the day, and in the regeneration mode during the night. In a further example, geofencing may be employed, and the fan assembly 500 may operate in the regeneration mode when a user is no longer present in the room or building in which the fan assembly 500 is located.

The illustrated HVAC system 400 and refrigeration system 10 are for the fan assembly 500, and so are sized so as to provide sufficient cooling to a person or a room. In this way, the refrigeration system 10 is relatively small compared, for example, to a refrigeration system of a building and/or an industrial HVAC system. For example, the refrigeration system 10 may be charged with up to 100 g, up to 150 g, up to 200 g or over 200 g of refrigerant, and the accumulator may be sized to accommodate up to 100 ml, up to 150 ml, up to 200 ml, up to 250 ml or more than 250 ml of liquid refrigerant.

It will be appreciated, however that the present invention may be employed in any other suitable HVAC, such a building and/or industrial HVAC system. In such a HVAC system, the refrigeration system 10 and components thereof, particularly the accumulator 300, may be correspondingly larger and sized for their intended purpose.

In the above examples, the pressure and temperature of the refrigerant are not reduced by the metering device 80 in the second mode. However, it is conceivable that the pressure and temperature of the refrigerant may be reduced by the metering device 80 in the second mode by a small amount providing that refrigerant flowing through the first heat exchanger 60 is at a higher temperature than the air. However, this may result in the effectiveness with which the refrigeration system 10,110 may cool the air at the first heat exchanger 60 in the first mode being reduced.

In the examples described above, the refrigeration system is used to cool air at the first heat exchanger 60. However, the refrigeration system 10,110 may be used to cool an alternative medium at the first heat exchanger 60, such as another gas or a liquid. Additionally, whilst the above examples comprise a blower 30, the blower 30 may be omitted and other mechanisms, such as convection or a pump, may be relied upon to move the medium over the first heat exchanger 60.

The above embodiments are to be understood as illustrative examples of the invention. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A refrigeration system comprising a circuit around which a refrigerant is circulatable, the circuit comprising:
a compressor;
a heat exchanger for exchanging heat between the refrigerant and a medium; and
an accumulator for accommodating liquid refrigerant, the accumulator fluidically coupled in a suction line between the heat exchanger and the compressor;
wherein the refrigeration system is operable in a cooling mode such that the medium is cooled at the heat exchanger; and
wherein the accumulator is oversized at a maximum cooling capacity of the refrigeration system in the cooling mode.

2. The refrigeration system of claim 1, wherein the accumulator comprises a chamber for storing refrigerant, and an outlet comprising a standpipe configured to open into the chamber.

3. The refrigeration system of claim 2, wherein the accumulator is configured so that the standpipe always opens into the chamber above a free surface level of liquid refrigerant in the chamber when the refrigeration system is operated in the cooling mode.

4. The refrigeration system of claim 1, wherein the circuit comprises a further heat exchanger for exchanging heat between the refrigerant and a thermal store.

5. The refrigeration system of claim 4, wherein the thermal store comprises a phase change material.

6. The refrigeration system of claim 4, wherein, in the cooling mode, the thermal store is heated at the further heat exchanger.

7. The refrigeration system of claim 6, wherein the circuit comprises a metering device having a first restriction in the cooling mode, and
wherein the refrigeration system is operable in a regeneration mode in which the metering device has a second restriction, less restrictive than the first restriction, or is bypassed, such that the thermal store is cooled at the further heat exchanger and the medium is heated at the heat exchanger.

8. The refrigeration system of claim 7, wherein the accumulator is sized to accommodate liquid refrigerant in the refrigeration system when the refrigeration system is operated in the regeneration mode.

9. The refrigeration system of claim 7, wherein the accumulator is configured so that the standpipe opens into the chamber above a free surface level of refrigerant in the chamber when the refrigeration system is operated in the regeneration mode.

10. The refrigeration system of claim 7, configured so that the refrigerant circulates around the circuit in the same direction in both the cooling mode and the regeneration mode.

11. The refrigeration system of claim 7, configured so that the refrigerant undergoes a phase transition in the cooling mode only.

12. The refrigeration system of claim 7, wherein the metering device comprises a variable expansion valve and/or the circuit comprises a bypass valve for bypassing the metering device.

13. A refrigeration system as claimed in claim 7, wherein the refrigeration system comprises a controller for switching between the cooling mode and the regeneration mode in response to an input.

14. A heating, ventilation, and air conditioning (HVAC) system comprising the refrigeration system of claim 1.

15. A fan assembly comprising the refrigeration system of claim 1.

16. A fan assembly comprising the HVAC system of claim 14.
